(19) United States
(12) Patent Application Publication
(10) Pub. No.: US 2017/0068987 A1
(43) Pub. Date: Mar. 9, 2017

(54) Measuring Advertisement Lift

(71) Applicant: Facebook, Inc., Menlo Park, CA (US)

(72) Inventors: Michael Daniel Levinson, Palo Alto, CA (US); William Bullock, Palo Alto, CA (US); Nathan John Davis, Woodside, CA (US); Chinmay Deepak Karande, Mountain View, CA (US)

(21) Appl. No.: 14/847,070

(22) Filed: Sep. 8, 2015

(51) Int. Cl. G06Q 30/02

(52) U.S. Cl. CPC G06Q 30/0246; G06Q 30/0275

(57) ABSTRACT

An advertisement system measures an ad lift metric for advertisement campaigns, which indicates the increase in conversions that can be attributed to the advertisement campaign. As impression opportunities become available for users for the ad in the lift study, the advertisement system determines whether the user is in a test group or a control group. To limit bias in the lift study, rather than holding out ads from being provided to users after the ad has been selected for the user and right before the impression, the system holds out the ads at a higher level in the ad selection process. In this manner, not all test group users receive the advertisement. The system computes the lift metric as e.g., the incremental lift (difference between conversion rates in the test and control groups), and this is divided by conversion rate of an exposed target group minus the incremental lift.

### BACKGROUND

This invention relates generally to evaluating the performance of advertisement campaigns.

An important metric in evaluating the performance of advertisement campaigns is the advertisement lift metric. The lift metric evaluates the effectiveness of a given advertisement by measuring the increase in conversions that can be attributed to the advertisement campaign. This metric allows advertisers to determine the effectiveness of given advertisement content and/or the effectiveness of the advertisement platforms on which the advertisement content is presented.

Measuring the lift metric of an advertisement campaign involves dividing a group of users into a test group and a control group such that only the test group is presented with the advertisement. The difference in conversion between the two groups provides a measure of the lift metric. Typical implementations of measuring lift metric do not account for how the group of users is divided into the test group and the control group, and when the advertisement selection process the advertisement is held out from presentation to the control group. This results in inaccurate and biased results because of the ultimate inconsistencies between the overall consumer experiences among the two groups. For example, holding out the control group from receiving the advertisement just before the advertisement impression can affect the test and control groups, thereby biasing the lift study.

### SUMMARY

An advertisement system computes a measure of lift or a lift metric for an advertisement. In a complex advertisement system that has intelligent per-user click predictions, holding out the ads from the control group of users just before the impression (e.g., after the ad has gone through an ad selection process that has ultimately selected the ad to be displayed to the user) can affect the test and control groups. This can bias the study because the control group users then get targeted less often than the test group users. In addition, information may be learned about test group users who received and interacted with the ads, and this information may then be used in future ad selection for those test group users, but this same information is not learned for the control group that never had the opportunity to interact with the ads.

To limit this bias, the advertisement system holds out the ad from the control group users at a higher level in the ad stack or ad selection process. The ad stack or ad selection process is an advertisement flow that includes various steps that ultimately result in the selection of ads for a user, such as selecting a number of candidate ads whose targeting criteria the user meets, ranking the candidate ads based on relevance to the user and other factors, passing the ads to an ad auction via which bids for the ads are considered in the selection, and finally selecting the ad that will be displayed from amongst the candidates. Rather than holding out the ad from the control group right before the impression or after the final selection has occurred, the ad can be held out earlier in the ad selection process (e.g., before ranking or ad auction) such that it is still possible to select another ad for the control group user.

In addition, users are not divided into test and control groups in advance of the study but instead are determined at the time of the ad selection process. As there is an impression opportunity for a user, a computation is performed (e.g., using a hash algorithm) to randomly assign the user to the test or control group. Then the user is allowed to complete the ad selection process. But for control group users, the advertisement in the lift study is held out at some point in the process. For test group users, the advertisement is not held out. Since the test group users have not yet finished the ad selection process, the advertisement in the lift study may not ultimately be selected for some of the test group users. Thus, some users logged into the test group do not receive the advertisement in the lift study. The test group users who do receive the ad make up a subset or exposed target group of test users. Lift can be computed using all users of the test group, using the assumption that the only difference between the test and control group is that some of the test group received an impression. The system measures the difference in conversion rates between the full (exposed and unexposed) test group and the control group. For example, the lift metric can be computed by (1) determining the incremental number of converters (number of converters directly attributable to the ad), which determined by subtracting the converters in the control group from the converters in the test group, (2) determining the implied baseline number of converters (the people who would have converted even if they had not received the ad), which is determined by subtracting the incremental converters from the converters in the exposed target group, and (3) dividing the number of incremental converters by the implied baseline number of converters.

### BRIEF DESCRIPTION OF THE DRAWINGS

FIG. 1 is a block diagram of a system environment in which an advertisement system operates, in accordance with an embodiment of the invention.

FIG. 2 is a block diagram of an advertisement system, in accordance with an embodiment of the invention.

FIG. 3A is a block diagram of a social networking system, in accordance with an embodiment of the invention.

FIG. 3B is a block diagram of an advertisement system, in accordance with an embodiment of the invention.

FIG. 4A is a diagram illustrating the stages of executing an advertisement lift study for a given advertisement campaign, in accordance with an embodiment of the invention.

FIG. 4B is a diagram illustrating the test and control groups selected for the advertisement lift study for a given advertisement campaign, in accordance with an embodiment of the invention.

FIG. 5 is an interaction diagram illustrating interactions between the ad requester and the ad selector to execute a lift study for a given user, in accordance with an embodiment of the invention.

FIG. 6 is a flow diagram of a process for computing a lift metric associated with an advertisement campaign, in accordance with an embodiment of the invention.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### System Architecture

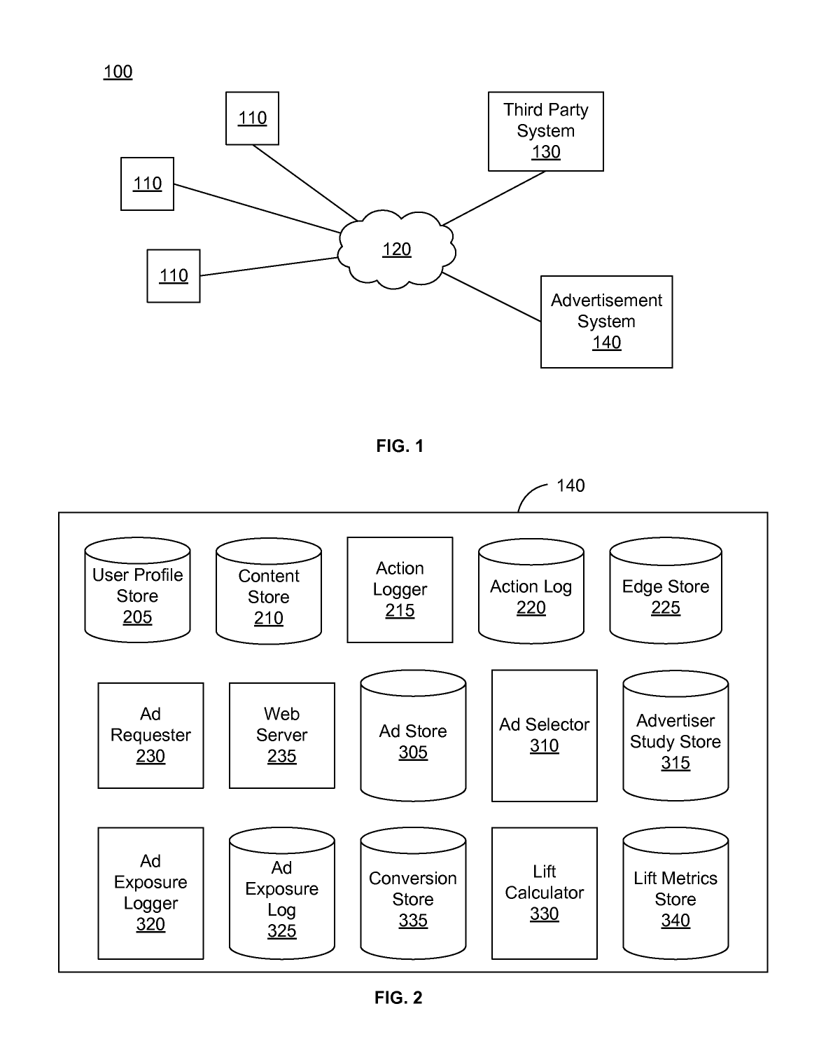

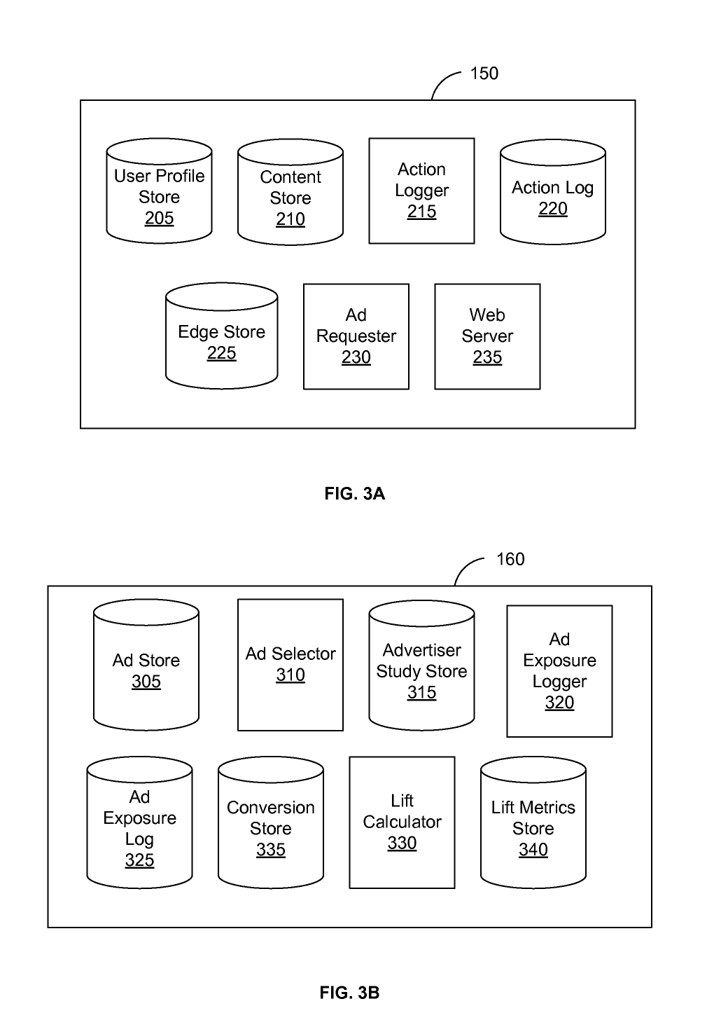

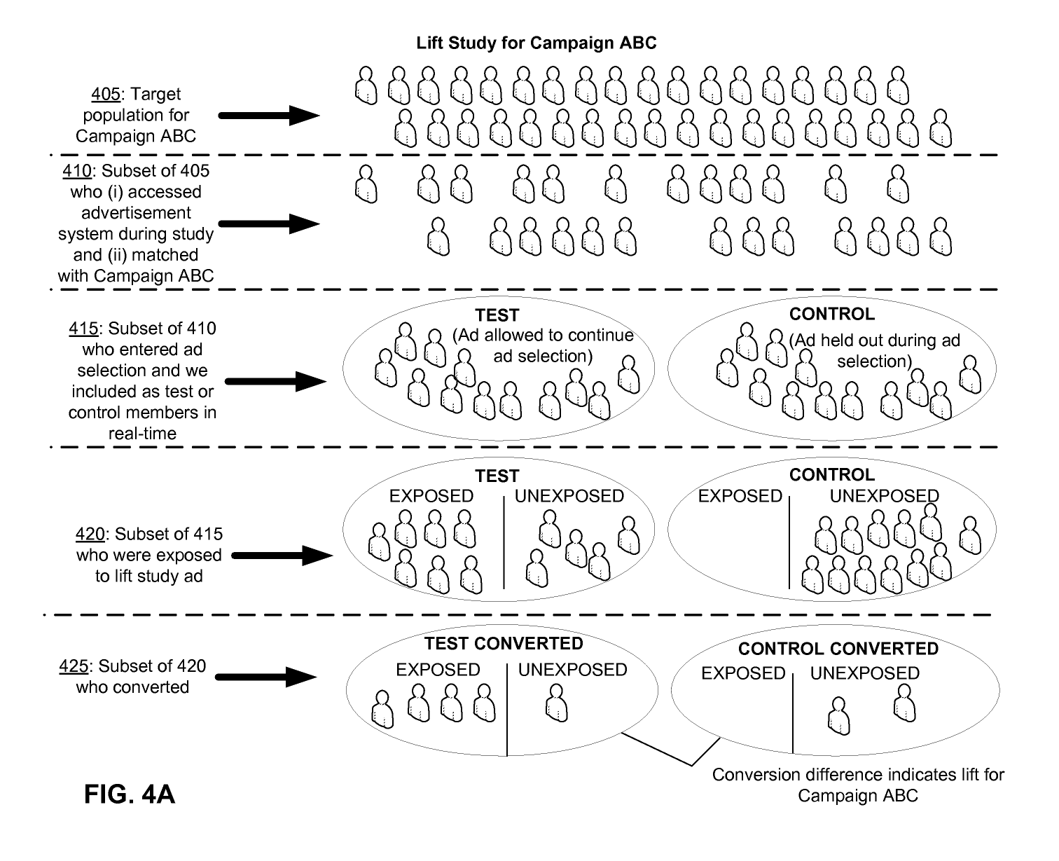

FIG. 1 is a block diagram of a system environment 100 for an advertisement system 140. The system environment 100 shown by FIG. 1 comprises one or more client devices 110, a network 120, one or more third-party systems 130, and an advertisement system 140. In alternative configurations, different and/or additional components may be included in the system environment 100. For example, in some embodiments, the advertisement system 140 is a social networking system or includes components of a social networking system, as is shown in FIG. 2. In other embodiments, a social networking system is a separate component of the system environment that interacts with the advertisement system 140. FIGS. 3A-3B illustrate the embodiment in which the social networking system 150 is a separate system from an advertisement system 160. In still further embodiments, there is no social networking system and the advertisement system 160 operates alone. The embodiments described herein can also be adapted to online systems that are not social networking systems or advertisement systems.

The client devices 110 are one or more computing devices capable of receiving user input as well as transmitting and/or receiving data via the network 120. In one embodiment, a client device 110 is a conventional computer system, such as a desktop or laptop computer. Alternatively, a client device 110 may be a device having computer functionality, such as a personal digital assistant (PDA), a mobile telephone, a smartphone or another suitable device. A client device 110 is configured to communicate via the network 120. In one embodiment, a client device 110 executes an application allowing a user of the client device 110 to interact with the advertisement system 140. For example, a client device 110 executes a browser application to enable interaction between the client device 110 and the advertisement system 140 via the network 120. In another embodiment, a client device 110 interacts with the advertisement system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third party systems 130 may be coupled to the network 120 for communicating with the advertisement system 140, which is further described below in conjunction with FIG. 2. In one embodiment, a third party system 130 is an application provider communicating information describing applications for execution by a client device 110 or communicating data to client devices 110 for use by an application executing on the client device. In other embodiments, a third party system 130 provides content or other information for presentation via a client device 110. A third party website 130 may also communicate information to the advertisement system 140, such as advertisements, content, or information about an application provided by the third party website 130.

FIG. 2 is a block diagram of an architecture of the advertisement system 140. The advertisement system 140 shown in FIG. 2 includes a user profile store 205, a content store 210, an action logger 215, an action log 220, an edge store 225, an ad requester 230, a web server 235, an ad store 305, an ad selector 310, an advertiser study store 315, an ad exposure logger 320, an ad exposure log 325, a conversion store 335, a lift calculator 330, and a lift metrics store 340. In other embodiments, the advertisement system 140 may include additional, fewer, or different components for various applications. For example, the advertisement system 140 may not include certain social networking components. FIG. 3B illustrates one example of this embodiment of the advertisement system. Conventional components such as network interfaces, security functions, load balancers, failover servers, management and network operations consoles, and the like are not shown so as to not obscure the details of the system architecture.

Each user of the advertisement system 140 is associated with a user profile, which is stored in the user profile store 205. A user profile includes a unique identifier associated with the user, declarative information about the user that was explicitly shared by the user and may also include profile information inferred by the advertisement system 140. In one embodiment, a user profile includes multiple data fields, each describing one or more attributes of the corresponding user of the advertisement system 140. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with identification information of users of the advertisement system 140 displayed in an image. A user profile in the user profile store 205 may also maintain references to actions by the corresponding user performed on content items in the content store 210 and stored in the action log 220.

While user profiles in the user profile store 205 are frequently associated with individuals, allowing individuals to interact with each other via the advertisement system 140, user profiles may also be stored for entities such as businesses or organizations. This allows an entity to establish a presence on the advertisement system 140 for connecting and exchanging content with other users. The entity may post information about itself, about its products or provide other information to users of the advertisement system using a brand page associated with the entity's user profile. Other users of the advertisement system may connect to the brand page to receive information posted to the brand page or to receive information from the brand page. A user profile associated with the brand page may include information about the entity itself, providing users with background or informational data about the entity.

The content store 210 stores objects that each represent various types of content. Examples of content represented by an object include a page post, a status update, a photograph, a video, a link, a shared content item, a gaming application achievement, a check-in event at a local business, a brand page, or any other type of content. Users may create objects stored by the content store 210, such as status updates, photos tagged by users to be associated with other objects in the system, events, groups or applications. In some embodiments, objects are received from third-party applications or third-party applications separate from the advertisement system 140. In one embodiment, objects in the content store 210 represent single pieces of content, or content “items.” Hence, users of the advertisement system 140 are encouraged to communicate with each other by posting text and content items of various types of media through various communication channels. This increases the amount of interaction of users with each other and increases the frequency with which users interact within the advertisement system 140.

The action logger 215 receives communications about user actions internal to and/or external to the advertisement system 140, populating the action log 220 with information about user actions. Examples of actions include adding a connection to another user, sending a message to another user, uploading an image, reading a message from another user, viewing content associated with another user, attending an event posted by another user, among others. In addition, a number of actions may involve an object and one or more particular users, so these actions are associated with those users as well and stored in the action log 220.

The action log 220 may be used by the advertisement system 140 to track user actions on the advertisement system 140, as well as actions on third party systems 130 that communicate information to the advertisement system 140. Users may interact with various objects on the advertisement system 140, and information describing these interactions are stored in the action log 210. Examples of interactions with objects include: commenting on posts, sharing links, and checking-in to physical locations via a mobile device, accessing content items, and any other interactions. Additional examples of interactions with objects on the advertisement system 140 that are included in the action log 220 include: commenting on a photo album, communicating with a user, establishing a connection with an object, joining an event to a calendar, joining a group, creating an event, authorizing an application, using an application, expressing a preference for an object (“liking” the object) and engaging in a transaction. Additionally, the action log 220 may record a user's interactions with advertisements on the advertisement system 140 as well as with other applications operating on the advertisement system 140. In some embodiments, data from the action log 220 is used to infer interests or preferences of a user, augmenting the interests included in the user's user profile and allowing a more complete understanding of user preferences.

The action log 220 may also store user actions taken on a third party system 130, such as an external website, and communicated to the advertisement system 140. For example, an e-commerce website that primarily sells sporting equipment at bargain prices may recognize a user of an advertisement system 140 through a social plug-in enabling the e-commerce website to identify the user of the advertisement system 140. Because users of the advertisement system 140 are uniquely identifiable, e-commerce websites, such as this sporting equipment retailer, may communicate information about a user's actions outside of the advertisement system 140 to the advertisement system 140 for association with the user. Hence, the action log 220 may record information about actions users perform on a third party system 130, including webpage viewing histories, advertisements that were engaged, purchases made, and other patterns from shopping and buying.

In one embodiment, an edge store 225 stores information describing connections between users and other objects on the advertisement system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the advertisement system 140, such as expressing interest in a page on the system, sharing a link with other users of the system, and commenting on posts made by other users of the system.

In one embodiment, an edge may include various features each representing characteristics of interactions between users, interactions between users and object, or interactions between objects. For example, features included in an edge describe rate of interaction between two users, how recently two users have interacted with each other, the rate or amount of information retrieved by one user about an object, or the number and types of comments posted by a user about an object. The features may also represent information describing a particular object or user. For example, a feature may represent the level of interest that a user has in a particular topic, the rate at which the user logs into the advertisement system 140, or information describing demographic information about a user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the advertisement system 140 over time to approximate a user's affinity for an object, interest, and other users in the advertisement system 140 based on the actions performed by the user. A user's affinity may be computed by the advertisement system 140 over time to approximate a user's affinity for an object, interest, and other users in the advertisement system 140 based on the actions performed by the user. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

In some instances, where there is a separate social networking system (see FIGS. 3A and 3B), as users operate and/or consume content on the social networking system 150, the ad requester 230 operates in conjunction with the advertisement system 160, which is described in greater detail in conjunction with FIGS. 3A and 3B, to present advertisement content to the users. In particular, when a user is selected for presenting advertisements, the ad requester 230 transmits a request to the advertisement system 160 for one or more advertisements that may be presented to the user. In response to the request, the ad requester 230 receives content associated with one or more advertisements from the advertisement system 160 and presents that advertisement content to the user. In some embodiments, the ad requester 230 may not present to the user every advertisement received from the advertisement system 160. For each advertisement presented to the user, the ad requester 230 stores an impression event in the action log 220 that indicates that the advertisement was, in fact, presented to the user. The advertisement system 140 can operate in the same manner to present ad content to users.

The web server 235 links the advertisement system 140 via the network 120 to the one or more client devices 110, as well as to the one or more third party systems 130. The web server 140 serves web pages, as well as other web-related content, such as JAVA®, FLASH®, XML and so forth. The web server 235 may receive and route messages between the advertisement system 140 and the client device 110, for example, instant messages, queued messages (e.g., email), text messages, short message service (SMS) messages, or messages sent using any other suitable messaging technique. A user may send a request to the web server 235 to upload information (e.g., images or videos) that are stored in the content store 210. Additionally, the web server 235 may provide application programming interface (API) functionality to send data directly to native client device operating systems, such as IOS®, ANDROID™, WEBOS® or RIM®.

The remaining components of the advertisement system 140 are described below in relation to FIGS. 3A and 3B that illustrate the embodiment in which there is a separate social networking system and advertisement system. These components generally function the same in the advertisement system 140 as they do when the advertisement system 160 and social networking system 150 are separate.

FIGS. 3A and 3B are block diagrams of a social networking system 150 and advertisement system 160, respectively. The social networking system 150 of FIG. 3A includes a user profile store 205, a content store 210, an action logger 215, an action log 220, an edge store 225, an ad requester 230, a web server 235, which operate in generally the same manner as described above for FIG. 2. The advertisement system 160 shown in FIG. 3B includes an ad store 305, an ad selector 310, an advertiser study store 315, an ad exposure logger 320, an ad exposure log 325, a conversion store 335, a lift calculator 330, and a lift metrics store 340, similar to those show in FIG. 2 for the advertisement system 140. In other embodiments, the social networking system 150 and advertisement system 160 may include additional, fewer, or different components for various applications. Conventional components such as network interfaces, security functions, load balancers, failover servers, management and network operations consoles, and the like are not shown so as to not obscure the details of the system architecture.

The ad store 305 stores one or more advertisement campaigns (“ad campaigns”) provided by various advertisers. An advertisement campaign or a single ad can be associated with a unique ad identifier (“ad ID”) and includes advertisement content and a bid amount. The advertisement content is text, image, audio, video, or any other suitable data presented to a user. In various embodiments, the advertisement content also includes a landing page specifying a network address to which a user is directed when the advertisement is accessed. The bid amount is associated with an advertisement by an advertiser and is used to determine an expected value, such as monetary compensation, provided by an advertiser to the advertisement system 140, 160 if the advertisement is presented to a user, if the advertisement receives a user interaction, or based on any other suitable condition. For example, the bid amount specifies a monetary amount that the advertisement system 150 receives from the advertiser if the advertisement is displayed and the expected value is determined by multiplying the bid amount by a probability of the advertisement being accessed.

Additionally, an advertisement campaign may include one or more targeting criteria specified by the advertiser. Targeting criteria included in an advertisement campaign specify one or more characteristics of users eligible to be presented with content in the advertisement campaign. For example, targeting criteria are a filter to apply to fields of a user profile, edges, and/or actions associated with a user to identify users having user profile information, edges or actions satisfying at least one of the targeting criteria. Hence, the targeting criteria allow an advertiser to identify groups of users matching specific targeting criteria, simplifying subsequent distribution of content to groups of users. The targeting criteria can be used to define a target population for an ad or ad campaign. For example, the target population for an ad may be males between the ages of 18 and 34 who live in the U.S. and who like cooking.

In one embodiment, the targeting criteria may specify actions or types of connections between a user and another user or object of the advertisement system 140, 160. The targeting criteria may also specify interactions between a user and objects performed external to the advertisement system 140, 160, such as on a third party system 130. For example, the targeting criteria identifies users that have taken a particular action, such as sending a message to another user, using an application, joining a group, leaving a group, joining an event, generating an event description, purchasing or reviewing a product or service using an online marketplace, requesting information from a third-party system 130, or any other suitable action. Including actions in the targeting criteria allows advertisers to further refine users eligible to be presented with content from an advertisement campaign. As another example, targeting criteria may identify users having a connection to another user or object or having a particular type of connection to another user or object.

The ad selector 310 receives requests for advertisements to be presented to users accessing the advertisement system 140 or 160. In embodiments where there is a separate social networking system 150, the requests may be received from that system 150. Each request received includes at least a unique user identifier (“user ID”) associated with the user to whom an advertisement is to be presented. For example, if an impression opportunity becomes available for a given user, the ad selector 310 can receive the user ID for that user. In response to such a request, the ad selector 310 performs or implements an ad selection process to select ads for the user for whom there is an impression opportunity. The ad selector 310 selects candidate advertisement campaigns in the ad store 305 having targeting criteria satisfied by information associated with the user to be presented with the advertisement. In some embodiments, the ad selector 310 requests the information associated with the user from the social networking system 150. Such information may include information from the user's user profile stored in the user profile store 205 or actions taken by the user within the social networking system 150 and stored in the action log 220.

From the candidate advertisement campaigns, the ad selector 310 selects an advertisement campaign via the ad selection process. The candidate ads may be ranked for the user based on a variety of factors, including the relevance of the ad content to the user, affinity of the user for the ad content or the product or brand, the user's preferences, the user's profile, prior actions the user has taken (e.g., clicking on ads or not, hiding ads, etc.) on the advertisement system or outside of this system, likelihood of a conversion by the user, among other factors. In addition, candidate ads or potentially the ranked candidate ads can be entered into an ad auction. For example, the ad selector 310 may conduct an auction process based on the bid prices of the candidate advertisement campaigns. Out of the auction process can come one or more ads selected for the user. Once the ad or advertisement campaign is finally selected, the ad selector 310 transmits the advertisement content to the ad requester 230 for presentation to the user. One or more of the candidate ads in the ad selection process may be ads that are tagged with a lift study, which affects the way that ad is treated and causes certain steps to be performed for that ad that relate to the implementation of the lift study. This is described in more detail in the sections below.

### Measuring Ad Lift

The goal of an advertisement campaign can be to increase conversions by users to whom the advertisement content is presented. The ad lift metric for a given advertisement campaign quantifies the actual increase in conversions that can be attributed to the advertisement campaign. Measuring ad lift is beneficial to both the advertiser and the advertising platform. Specifically, the measurement gives insights into how the advertisement is performing and how to divide the advertisement budget across different advertisement platforms. Further if, prior to the conversion, a converting user was presented with multiple advertisements on the same platform or on different platforms, the lift measurement of an advertisement may be used to determine how much of the conversion (and, thus, the advertisement spend) should be attributed to that advertisement.

Along with selecting advertisement content for presentation, the advertisement system 150 also measures the ad lift metric for advertisement campaigns. Specifically, when the ad selector 310 selects advertisement content of ad campaigns for inclusion in the ad selection process as candidates for a user, the ad selector 310 at some point in the ad selection also determines whether any of the candidates are currently a part of a lift study. A lift study is set-up by an advertiser or by the advertisement system to determine the “lift,” i.e., an increase in conversions that can be attributed to one or more advertisement campaigns. The system receives an indication to include the ad in a lift study. The advertiser study store 315 stores lift studies set up by advertisers. Each lift study stored in the advertiser study store 315 is defined by one or more parameters including (i) the ad ID(s) to be included in the study, (ii) the target population or number of users who should participate in the study, and (iii) the percentage of the participating users who should form the control group relative to the test group. The advertiser can also indicate a conversion type that is of interest, such as purchase of the product in the ad, signing up for an account, attending an event, etc. The control group includes users who are not shown advertisements associated with the advertisement campaign(s) being studied. The test group includes users who are selected to be shown advertisements associated with the advertisement campaign(s) being studied, though the ad may not be shown to all users of the test group. In some embodiments, the advertiser can include multiple ads of an ad campaign in the study such that the control group will receive no ads for that campaign.

When an advertisement campaign is part of a lift study, the ad selector 310 determines whether the user is a participant in the lift study, or if all users who meet the targeting criteria are to be included, the user may automatically be included once a match with the targeting criteria is determined. The ad selector 310 also determines whether the user will participate in the study in the control group or in the test group. The ad selector 310 determines or computes this in real time when there is an impression opportunity for the user, so the determination occurs during or right before the ad selection process. In one embodiment, the ad selector 310 uses a hash algorithm, an MD5 checksum, or other mechanism to randomly assign the user to test or control. For example, the system may use a hash of the user ID for the user. Since the advertiser or the advertisement system may have set in advance what percentage of users are to be included in the control group versus the test group, the method used to assign users to test and control groups accounts for this percentage to ensure that generally the right percentage of users are assigned to each group. The result of the computation about test or control group is logged in the ad exposure log 325 by the ad exposure logger 320. In this manner, the logger 320 begins to build populations of users in real time for both the test group and the control group. The ad exposure log 325 can include for each user the user ID, the associated ad ID for the ad in the lift study, and whether the user was put into test or control.

For users put into the control group, the lift study advertisement will be held out (e.g., removed from consideration as a candidate ad in the ad selection process) at some point in the ad selection process such that the advertisement is never finally selected for the user, which helps to avoid the problem of an ad being selected for a user and then being pulled at the last minute from display. The advertisement may be held out after it is initially selected as a candidate amongst various other ads, during or after a ranking of the ads occurs, right before or during an ad auction process, among other levels of the ad stack. In some embodiments, the system holds out the ad as soon as the user is determined to be a control group user. The assignment of a user to the control group can also happen at any point in the ad selection process before the final ad selection is made for the user. In some embodiments, the system holds out the ad as late in the ad stack as possible while still ensuring that the study is not biased and that the test and control groups really are randomly selected. The system can also run offline studies to test what is the lowest level in the ad stack at which the ad can be held out while still maintaining randomization. For example, if by holding out the ad at a certain level in the ad stack the system can predict which group a given user might be put into, the user assignment is not considered to be random and the level of holdout in the ad stack may be too low (e.g., to close to the final selection of the ad).

For users put into the test group, the lift study advertisement will be allowed to continue through the ad selection process such that the lift study ad may or may not be finally selected and shown to the test group user. Thus, some users who are declared test group users and logged by the system as being in the test group will not actually be exposed to the ad. The users in the test group who are exposed form a subset of the test group referred to as the exposed target group. The remaining test group users who do not receive the ad are in the unexposed target group along with the control group users who also did not receive the ad.

The information about exposure to ads in lift studies is stored in the ad exposure log 325. Specifically, for each advertisement campaign that is part of a study, the ad exposure logger 320 maintains a list of users in the test group who ultimately ended up being exposed to the ad (e.g., the ad selection process continued and the ad in the lift study was the one ultimately chosen for and shown to the user). The ad exposure logger 320 can also log users who were not exposed, such as test group users for whom the ad in the lift study was not ultimately selected and control group users for whom the ad in the lift study was held back.

This design of the lift study helps to avoid the problems with bias in the study that can come from pre-assigning users to a control or test group or from holding out an ad from a control group after the ad has been finally selected for the user. Holding out the ad at the last minute can result in the control group having an open ad slot or getting targeted less often, which can change the experience of control group users versus test group users, making the two groups not statistically the same for the purposes of the study. If they are not statistically the same, this causes problems in the lift calculation because it is not clear whether the lift occurred because of the ad shown to the user, which caused the user to buy the product, or if it was some other unrelated factor. As an example, if a user in the test group receives a lift study ad on day 1 and clicks on it, the system can learn that the user is interested in that ad, and so this can make the system more likely to rank higher and select the same ad for that user on day 2. However, if that user were instead put into the control group, the system would never learn this information about the user on day 1, and so the ranking of that ad on day 2 is different for this user. Thus, by virtue of putting the user into the control group, the lift study can be biased, and this bias can be greater the farther down in the ad stack you wait to hold out the ad for the control group, so the advertisement system described here limits this problem by holding the ad out higher in the ad stack.

When users of the advertisement system 140 or 160 convert, i.e., perform a desired action specified by an advertiser, the advertiser or system/website associated with the advertiser transmits notifications to the advertising system indicating that the user has converted (e.g., via a tracking pixel on one or more pages of the advertiser's website). The notification includes the user IDs of the users who converted. The notification may also include, for each user who converted, specific details about the conversion. For example, the notification may include an amount of money the user spent shopping on the advertiser's website. The advertising system 150 stores the notifications of conversions received from advertisers in the conversion store 335.

For each advertisement campaign in a lift study, the lift calculator 330 generates lift metrics for the campaign based on information about the study participants stored in the ad exposure log 325 and the conversion notifications stored in the conversion store 335. The lift calculator 330 stores the generated metrics in the lift metrics store 340 and, in some cases, provides one or more reports related to the lift metrics to the advertiser associated with the campaign. The lift metric can be computed in various ways. In one embodiment, the lift calculator 330 computes the lift metric based on the difference between the number of converters in the test group and the number of converters in the control group. As discussed below, even though a portion of the test group may ultimately not be exposed to the test study ad, computing the lift metric based on the entire test and control groups results in more accurate lift metrics as the users in each group were identified at the same stage of the ad selection process.

The remaining discussion is of the details of measuring the ad lift for a given advertisement campaign, campaign ABC, stored in the ad store 305. For the purposes of discussion, assume that campaign ABC is associated with a target population as defined in ad store 305 and is also a part of a lift study stored in the study store 315. The lift study identifies the number of users who should participate in the study and the percentage of the participating users who should form the control group relative to the test group.

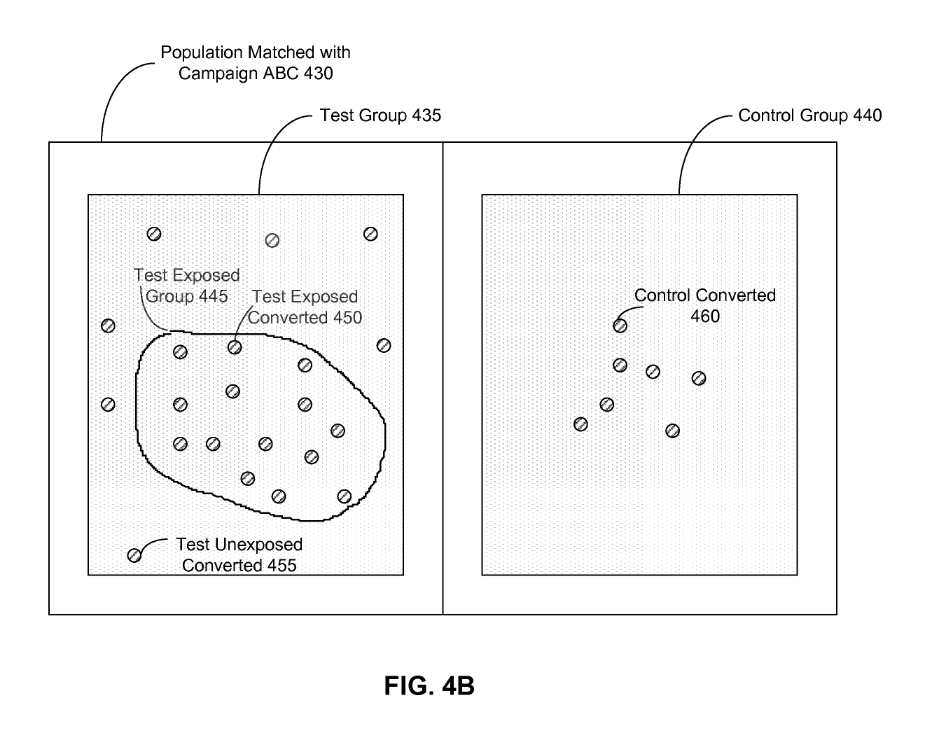

FIG. 4A is a diagram illustrating the stages of executing an advertisement lift study for campaign ABC. Stage 405 depicts the target population campaign ABC. The target population includes all of the users of the advertisement system who satisfy the targeting criteria (e.g., males, 18-24, living in the U.S., who like cooking) for campaign ABC provided by the advertiser. The targeting criteria specify one or more characteristics of users eligible to be presented with content in the advertisement campaign. In the illustration in FIG. 4, the entire target population is shown as being funneled through the different stages of executing the lift study. In operation, the advertisement selector 310 selects users as test or control study participants as it receives requests from the ad requester 230 for advertisement content.

Stage 410 depicts the subset of the target population of stage 405 who accessed the advertisement system or became available on the system for an ad impression during the period of the lift study for campaign ABC was ongoing and whom the ad selector 310 matched with campaign ABC.

Stage 415 depicts the subset of the population at stage 410 who entered the ad selection process or who were otherwise determine to be eligible for the ad or were reasonable candidates for the ad. This group 415 could include all of the members of 410 (or there may be no stage 410), or could be a subset of 410. For example, there may be some people who access the advertisement system in group 410 but are not eligible to receive the ad for some reason. Once users get into the subset 415 and enter the ad selection process, the advertisement system at some point will determine whether they should be included in the test or control group and will log this data. For test users, the lift study ad continues through the ad selection process and may be selected for the user. For control users, the lift study ad is held out at some point in the ad selection process. Selecting the participants at this stage provides for a more accurate lift calculation because the content consumption experience for both the control group and the test group is largely the same and not impacted by the lift study. Specifically, at this stage, the advertising system 150 can correct for the control group being held from receiving the advertisement content by presenting different advertisement content or some other content to the control group. If the control group is selected later in the advertisement selection and presentation process, then in some cases the control group may be subjected to a different experience relative to the test group. This disparity in experiences would have an impact on the lift calculation that is avoided by the selection process depicted in stage 415.

Stage 420 depicts the subset of the test group and control group who were exposed to the ad in the lift study. Since the ad was held out for control group users, none of those users are exposed to the ad. For the test group users, only some of them receive ad as the ad may or may not be ultimately selected for them in the ad selection process.

Stage 425 depicts the subset of the exposed target subset 420 of the test group who converted and the subset of the control group of 415 who converted. The conversion difference between the test group and the control group indicates the difference in the conversion rates of the test group and the control group. The conversion difference, therefore, can be attributed to the lift provided by campaign ABC.

FIG. 4B is a diagram illustrating the test and control groups selected for the advertisement lift study for campaign ABC. The population 430 includes the users of the advertisement system who satisfy the targeting criteria for campaign ABC provided by the advertiser. The control group 440 includes the users who are selected to participate in the lift study for campaign ABC and for whom the lift study ad is held out at some point in the ad selection process. The test group 435 includes the users who are selected to participate in the lift study for campaign ABC and for whom the lift study ad continues through the ad selection. The test exposed group 445 includes the users in the test group 435 who were ultimately exposed to the lift study ad. The test exposed converted 450 includes the users in the group 445 who converted as a result of the exposure. The test unexposed converted 455 includes the users in the group 435 who were not exposed to the ad but still converted. The control converted 460 includes users in the group 440 who converted.

To compute the lift metric for campaign ABC, the lift calculator 330 determines the number of users in the test group 435 who converted (450 and 455) and the number of users in the control group 440 who converted (460). Generally, the total number of users in the test and control groups is the same or within an error margin of one another, e.g., plus/minus 50 users. In cases where the number of users in the test group is much larger than the number of users in the control group (e.g., twice as large), the lift calculator 330 scales the number of users in the control group such that the scaled number is equal to the number of users in the test group. In such a scenario, the number of users in the control group who converted also needs to be scaled. For this scaling, the lift calculator 330 first determines the conversion rate for the control group prior to the scaling. The lift calculator 330 then computes the scaled number of users who converted by multiplying the computed conversion rate by the scaled number of users in the control group.

To illustrate a scenario where scaling would be beneficial, assume that the test group has 1,000 users of whom 220 users converted and the control group has 500 users of whom 40 users converted. During the lift metric calculation, the lift calculator determines the conversion rate for the control group as eight percent (40 divided by 500). The lift calculator 330 also scales the number of users in the control group by a factor of two to match the number of users in the test group. The lift calculator 330 then determines the number of users who would have converted in the scaled control group based on the conversion rate for the control group as eight percent of 1,000, which equals to 80.

Returning to the lift metric calculation, once the number of users who converted in each of the test group 435 and the control group 440 is determined, the lift calculator 330 computes the incremental lift as the difference between the two numbers. The incremental lift is an accurate measure of the number of conversions that can be attributed to the ad campaign. The lift calculator 330 also computes a baseline number of converters, i.e., the number of users who would have converted even if the users were not exposed to the lift study ad. To compute the baseline number, the lift calculator 330 subtracts the incremental lift from the number of users included in the test exposed converted group 445. This resulting number quantifies the number of users who would have converted without being exposed to the lift study ad. The baseline number is computed using the test exposed converted group 445 as opposed to the test group 435 based on the assumption that any measurable lift in conversions among the test group and the control group can reliably be attributed to the lift study ad being exposed to the users.

The lift calculator 330 then computes the lift metric as the percentage increase in conversions caused by the lift study ad relative to the baseline number of converters. Specifically, the lift calculator divides the incremental lift by the baseline number of converters to quantify the percentage increase in conversions. This lift metric is stored in the lift metrics store 340.

Table 1 provides another illustration of the building of the test and control populations.

TABLE 1

| | TEST | CONTROL |
|---|---|---|
| Target audience | 260k | 40k |
| Users at ad stack level | 80k | 80k |
| Users who received lift | 67k | 0k |
| study ad | | |
| Users converted | 8k | 1.8k |
| % conversion | 10% (12% exposed) | 2.25% |
| Sales | $800k | 150k |
| Amount per user | $100/each | $75/each |

In this example, the target audience includes 300k users total, and users who make it to the ad selection process are about 160k. At some point in this ad stack level, the 160k users are divided into a test group of 80k and a control group of 80k. Also at some point in this level, the lift study ad is held out from the 80k users. For the 80k test group, the lift study ad continues through the ad selection and is ultimately exposed to 67k of the 80k, so 13k of the test group remain unexposed. The users for whom a conversion event happened out of the 80k test users is 8k, and the users for whom a conversion happened out of the 80k control group is 1.8k. The conversion rate is calculated as people who converted of the test group divided by people in the test group, and the same for the control group. There was a 10% conversion for test group users and 2.25% conversion for control group users, so the ads were worth 7.75 extra percentage points (the “incremental lift”) and significantly more money ($800k versus $150k).

Since not all test users were exposed using the lift study design that is described here, the system calculates the baseline conversion rate based on the difference between the exposed target group who converted and the overall conversion rate. Specifically, of the 8k test group people who converted, some were in the 67k exposed and some were in the 13k unexposed. If the system is confident in the balance that the test and control groups are identical, the only difference between the test or control groups should be that the test group may have seen an ad. Thus, the system can assume any impact on the conversion by the lift study ad came in the 67k test users exposed and not in the 13k test users who were not exposed. Therefore, the baseline conversion rate, i.e., the rate at which users convert without being exposed to the ad, is calculated as the difference between the conversion rate of the exposed target group and the incremental lift. In this example, the baseline conversion rate would be 7.75% (the incremental lift) subtracted from 12% (the conversion rate of the exposed target group), which equals 4.25%. The lift metric, i.e., the percentage increase in conversions attributable to the ad, is then calculated by dividing the incremental lift by the baseline conversion rate. In this example, therefore, the lift metric percentage is 7.75% divided by 4.25% to yield a conversion percentage increase of 182%.

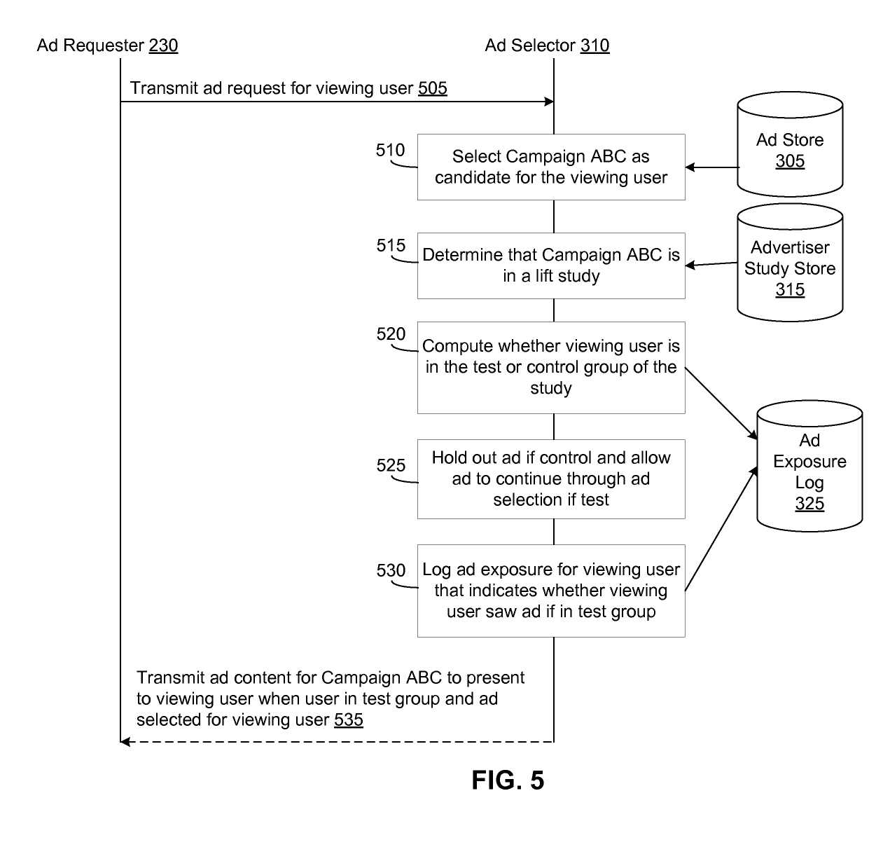

FIG. 5 is an interaction diagram illustrating interactions between the ad requester 230 and the ad selector 310 to execute a lift study for a given user. As a user operates and/or consumes content on the advertisement system, the ad requester 230 may select the user as a candidate for receiving advertisements. The ad requester 230 transmits 505 a request to the ad selector 310 in the advertisement system 150 for candidate advertisements that may be presented to the user. There may be hundreds or thousands of ads for which the user matches the targeting criteria and is eligible. In response, the ad selector 310 selects 510 the ads for which the user may be eligible including a given ad campaign, campaign ABC, from the ad store 305 for consideration in the ad selection process for the viewing user. The ad selection process can include a ranking of the candidate ads based on various factors such that the best ads for the user (e.g., best matches in terms of relevance, likelihood of user clicking the ad or converting based on the ad, among other factors) are ranked highest. The candidate ads can also go through an ad auction in which advertiser bids for placing the ad before the particular user are considered in selecting the ad. The available budget in the ad campaign can also be considered. The ad selection process ultimately results in the selection of an ad to show to the viewing user.

As part of the ad selection process, the ad selector 310 also determines 515 whether any ads are in lift studies, such as Campaign ABC that is currently a part of a lift study stored in the advertiser study store 315. Again, each lift study stored in the advertiser study store 315 is defined by one or more parameters, such as (i) the ad ID(s) to be included in the study, (ii) the number of users who should participate in the study (or all users can be selected to participate), and (iii) the percentage of the participating users who should form the control group relative to the test group.

The ad selector 310 computes 520 based on the lift study parameters whether to include the viewing user in the test or control group. In one embodiment, the ad selector 310 is configured with a function, such as a hash function, that processes the user ID associated with the viewing user to determine whether the viewing user should be a participant in the lift study in the test group or the control group. The ad selector 310 stores the determinations in the ad exposure log 325. When the user participates in the study in the control group, the advertisement content is held back 525 from the user. Conversely, when the user participates in the study in the test group, the advertisement content is not held back from the user, but is allowed 525 to continue through the ad selection process.

When an ad is selected for the test group user, if it is the Campaign ABC ad, the ad selector 310 logs 530 the ad exposure in the ad exposure log 325 and transmits 535 the advertisement content to the ad requester 230 for presentation to the user. The logging and transmission may occur simultaneously, or the logging may occur before or after the transmission.

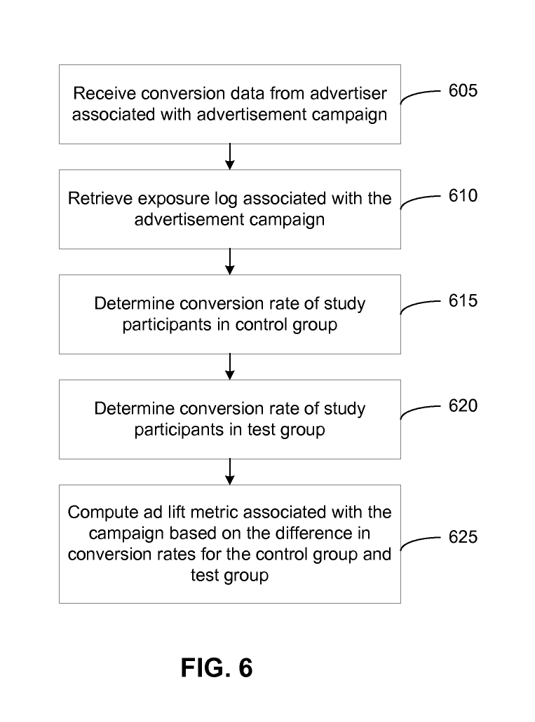

FIG. 6 is a flow diagram of a process for computing a lift metric associated with an advertisement campaign. For a given advertisement campaign in a lift study, the lift calculator 330 receives 605 conversion data from the advertiser associated with the advertisement campaign. The conversion data can include the user IDs of users who have converted, i.e., performed a desired action specified by an advertiser, or other identifying information. The conversion data may also include, for each user who converted, specific details about the conversion. For example, the notification may include an amount of money the user spent shopping on the advertiser's website. The lift calculator 330 stores the conversion data in the conversion store 335.

The lift calculator 330 also retrieves the exposure logs associated with the advertisement campaign and stored in the ad exposure log 335. As discussed above, the ad exposure log 335 maintains a list of participants of the lift study associated with the advertisement campaign and also indicates whether a given participant was in the control group or the test group of the study and whether the test group member was exposed to the ad. The user IDs of the users in the log 355 and in the conversion data from the advertiser can be matched up to determine specifically which users converted (and which group there were in along with whether they were exposed to the ad).

Based on the conversion data and the exposure log, the lift calculator 330 determines 615 the conversion rate of study participants in the control group. This control conversion rate indicates the number of participants in the control group who converted relative to the total number of participants in the control group. The lift calculator 330 also determines 620 the conversion rate of study participants in the test group, but can focus specifically on the exposed target group. This test conversion rate indicates the number of participants in the test group who converted relative to the total number of participants in the test group.

The lift calculator 330 computes 625 a lift metric for the advertisement campaign based on the difference between the control and the test groups for the advertisement campaign. The lift metric indicates the impact that the given advertisement campaign had on conversion. Specifically, the lift metric indicates whether the advertisements related to the advertisement campaign caused the test group (the users for whom the advertisements were selected for presentation) to convert at a higher rate relative to the control group (the users for whom the advertisements were not selected for presentation). The lift calculator 330 stores the generated metrics in the lift metrics store 340 and, in some cases, provides one or more reports related to the lift metrics to the advertiser associated with the campaign.

### CONCLUSION

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
receiving an indication to include an advertisement in a lift study, the advertisement associated with a target population of users;
performing an ad selection process to select ads for users of the target population as impression opportunities become available for the users;
for each of the users for whom the ad selection process is performed:
determining that the advertisement in the lift study is a candidate ad for the user,
computing whether to include the user in a test group or a control group for the lift study,
based on the computation indicating that the user is in the control group, holding out the advertisement from completing the ad selection process for the user such that another advertisement is selected for the user, and
based on the computation indicating that the user is in the test group, allowing the advertisement to continue through the ad selection process such that the user receives either the advertisement in the lift study or another advertisement; and
computing lift for the advertisement based on a difference in conversion rates between users of the test group and users of the control group.

2. The method of claim 1, further comprising logging users of the test group who receive the advertisement as an exposed target group that is a subset of the test group, wherein computing lift further comprises:
determining an incremental number of converters that is a difference between a number of converters in the test and control groups;
determining a baseline number of converters that is a number of converters in the exposed target group minus the incremental number of converters; and
dividing the incremental number of converters by the baseline number of converters.

3. The method of claim 1, wherein holding out the advertisement from completing the ad selection process for the user comprises holding out the advertisement before a final ad is selected such that the advertisement does not complete an ad auction.

4. The method of claim 1, wherein holding out the advertisement from completing the ad selection process for the user comprises holding out the advertisement before providing advertisements to an ad auction.

5. The method of claim 1, wherein holding out the advertisement from completing the ad selection process for the user comprises holding out the advertisement before ranking the advertisement along with other candidate ads for the user.

6. The method of claim 1, wherein holding out the advertisement from completing the ad selection process for the user comprises holding out the advertisement as late in the ad selection process as possible while still providing a randomly selected test group and control group.

7. The method of claim 1, further comprising logging user identifiers for users whom the advertisement is included in the ad selection process and logging whether the user is computed to be in the test group or the control group, thereby building a test population of users and a control population of users.

8. The method of claim 1, further comprising receiving from an advertiser associated with the advertisement a list of users who converted and matching the list to users in the test group and users in the control group to compute the lift for the advertisement.

9. The method of claim 1, wherein computing whether to include the user in a test group or a control group for the lift study comprises applying a hash algorithm to randomly assign users to the test group of the control group in real time as the ad selection process is occurring.

10. A computer program product comprising a non-transitory computer-readable storage medium containing computer program code for:
receiving an indication to include an advertisement in a lift study, the advertisement associated with a target population of users;
performing an ad selection process to select ads for users of the target population as impression opportunities become available for the users;
for each of the users for whom the ad selection process is performed:
determining that the advertisement in the lift study is a candidate ad for the user;
computing whether to include the user in a test group or a control group for the lift study;
based on the computation indicating that the user is in the control group, holding out the advertisement from completing the ad selection process for the user such that another advertisement is selected for the user, and
based on the computation indicating that the user is in the test group, allowing the advertisement to continue through the ad selection process such that the user receives either the advertisement in the lift study or another advertisement; and
computing lift for the advertisement based on a difference in conversion rates between users of the target group and users of the control group.

11. The computer program product of claim 10, wherein holding out the advertisement from completing the ad selection process for the user comprises holding out the advertisement before a final ad is selected such that the advertisement does not complete an ad auction.

12. The computer program product of claim 10, further comprising logging user identifiers for users whom the advertisement is included in the ad selection process and logging whether the user is computed to be in the test group or the control group, thereby building a test population of users and a control population of users.

13. The computer program product of claim 10, further comprising logging users of the test group who receive the advertisement as an exposed target group that is a subset of the test group.

14. The computer program product of claim 13, wherein computing the lift further comprises:
computing the conversion rate of the test group as a number of users in the test group who converted out of a total number of users in the test group;
computing the conversion rate of the control group as a number of users in the control group who converted out of a total number of users in the control group;
computing incremental lift as the difference between the conversion rate of the test group and the conversion rate of the control group;
computing a baseline conversion rate as the difference between the conversion rate of the exposed target group and the incremental lift; and
computing lift as the incremental lift divided by baseline conversion rate.

15. The computer program product of claim 10, wherein receiving an indication to include an advertisement in a lift study comprises receiving from an advertiser the advertisement, targeting criteria for the advertisement, a percentage of the target population that should be in the control group versus the test group, and an objective of the advertisement in terms of conversions.

16. A computer system comprising:
a processor;
a non-transitory computer-readable storage medium storing software modules executable by the processor to perform the steps comprising:
receiving an indication to include an advertisement in a lift study, the advertisement associated with a target population of users;
performing an ad selection process to select ads for users of the target population as impression opportunities become available for the users;
for each of the users for whom the ad selection process is performed:
determining that the advertisement in the lift study is a candidate ad for the user;
computing whether to include the user in a test group or a control group for the lift study;
based on the computation indicating that the user is in the control group, holding out the advertisement from completing the ad selection process for the user such that another advertisement is selected for the user, and
based on the computation indicating that the user is in the test group, allowing the advertisement to continue through the ad selection process such that the user receives either the advertisement in the lift study or another advertisement; and
computing lift for the advertisement based on a difference in conversion rates between users of the target group and users of the control group.

17. The computer system of claim 16, wherein holding out the advertisement from completing the ad selection process for the user comprises holding out the advertisement before a final ad is selected such that the advertisement does not complete an ad auction.

18. The computer system of claim 16, further comprising logging user identifiers for users whom the advertisement is included in the ad selection process and logging whether the user is computed to be in the test group or the control group, thereby building a test population of users and a control population of users.

19. The computer system of claim 16, further comprising receiving from an advertiser associated with the advertisement a list of users who converted and matching the list to users in the test group and users in the control group to compute the lift for the advertisement.

20. The computer system of claim 16, further comprising running an offline study for the lift study to determine whether it is possible to predict if a user will be assigned to the control group or the test group, wherein a negative result indicates that users are being assigned substantially randomly to the test group and the control group.
